(19) United States
(12) Patent Application Publication
(10) Pub. No.: US 2010/0168911 A1
(43) Pub. Date: Jul. 1, 2010

(54) METHOD AND APPARATUS FOR MANAGING ROBOT COMPONENTS

(75) Inventors: Seung-Woog Jung, Daejeon (KR); Choul Soo Jang, Daejeon (KR); Byoung Youl Song, Daejeon (KR); Sung Hoon Kim, Daejeon (KR); Joong Bae Kim, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/558,787

(22) Filed: Sep. 14, 2009

(30) Foreign Application Priority Data
Oct. 31, 2008 (KR) 10-2008-0107777
Jun. 1, 2009 (KR) 10-2009-0048043

(51) Int. Cl. G06F 19/00; G05B 15/00

(52) U.S. Cl. 700/245; 901/50

(57) ABSTRACT

An apparatus for managing robot components in an intelligent robot includes a robot application including a plurality of robot components, a robot application management tool that manages the operation of the robot application, monitors the status caused by the operations of the robot application and information on the robot components, a lifecycle manager that manages lifecycles of the robot components under the management of the robot application management tool, and an operation system that transfers a sensing signal about peripheral environment generated from the sensor to the robot application, and transfers an execution signal from the robot application to the actuator.

### CROSS-REFERENCE(S) TO RELATED APPLICATION(S)

The present invention claims priority of Korean Patent Applications No. 10-2008-0107777, filed on Oct. 31, 2008 and No. 10-2009-0048043, filed on Jun. 1, 2009, which are incorporated herein by reference.

### FIELD OF THE INVENTION

The present invention relates to the management of robot components in an intelligent robot, and more specifically, to a method and apparatus for managing robot components in an intelligent robot adapted to easily develop reusable robot components.

### BACKGROUND OF THE INVENTION

An intelligent robot actively provides a variety of services to a user, interacting with a changed peripheral environment. To this end, the robot includes all complicated functions such as image processing, autonomous running, speech recognition, speech synthesis, motor and sensor control, and user task execution. However, it is not easy for one robot enterprise to entirely develop the robot performing such a numerous functions. Consequently, pre-developed robot components are combined to develop a robot satisfying various functions. In addition, a real-time system such as a robot has a feature of performing diverse processes concurrently, or according to priorities.

Conventional method for developing a robot application prepares various functions in a spaghetti format to be mutually dependent without modularization. Thus, it is difficult to reuse a previously-prepared algorithm or program in the maintenance and development of a new robot application, and also difficult to easily develop a robot application executed concurrently with a data or event processing and a method call processing.

However, in the case of the conventional robot applications developed without using the robot component concept, since programs or major algorithms in the robot applications are mixed without modularization, a lot of efforts are required to reuse the robot applications in the development of another robot application. It is also extremely difficult to reuse an algorithm or program prepared by another enterprise. In addition, a robot application developer must implement all functions such as lifecycle management, data transfer, event transfer, method call, cyclic execution, and finite state machine processing, thereby considerably increasing a development period and a development cost.

### SUMMARY OF THE INVENTION

It is, therefore, an object of the present invention to provide a method and apparatus for managing robot components in an intelligent robot with improved reusability and maintenance.

Another object of the present invention is to provide a method and apparatus for managing robot components in an intelligent robot adapted for developing robot components with rapid and easy development of the robot components and with improvement of working convenience of a robot application developer.

In accordance with an aspect of the present invention, there is provided an apparatus for managing robot components in an intelligent robot having a sensor and an actuator, which includes:

a robot application including a plurality of robot components;

a robot application management tool that manages the operation of the robot application, monitors the status caused by the operations of the robot application and information on the robot components;

a lifecycle manager that manages lifecycles of the robot components under the management of the robot application management tool; and

an operation system that transfers a sensing signal about peripheral environment generated from the sensor to the robot application, and transfers an execution signal from the robot application to the actuator.

In accordance with another aspect of the present invention, there is provided a method for managing a plurality of robot components being executed by a lifecycle manager in an intelligent robot having a sensor and an actuator, which includes:

transferring a designated destination from a command process component to a robot movement component through a method port;

converting a sensing signal received by the sensor into sensor data in a sensing component;

transferring the sensor data to an obstacle sensing component to judge an existence or absence of obstacles based on the sensor data;

generating an event on the basis of judgment of the existence or absence of obstacles to transfer the event to the robot movement component; and

transferring to the actuator a control signal depending on the event transferred to the robot movement component and the destination transferred through the method port.

### BRIEF DESCRIPTION OF THE DRAWINGS

The above and other objects and features of the present invention will become apparent from the following description of embodiments, given in conjunction with the accompanying drawings, in which:

FIG. 1 is an apparatus for developing robot components in accordance with the present invention;

FIG. 2 illustrates the configuration of one of the robot components shown in FIG. 1;

FIG. 3 illustrates the port connection relation between the robot components; and

FIG. 4 illustrates a robot application prepared by a method for developing robot components in accordance with the present invention.

### DETAILED DESCRIPTION OF THE EMBODIMENTS

Herein, a robot component is a reusable and replaceable robot software module, and has a standardized format to easily develop and maintain the robot application. The application program executed in the robot is created by combining such robot components. The robot components developed under standard requirements can be reused in the future development of another robot application, and also can reduce a development time of the robot application. There is a further advantage of easily using a robot component developed by another enterprise. In addition, a standardized method for developing an intelligent robot is provided to easily develop a concurrently executed complicated robot application. Since the robot application executed in the intelligent robot has different features from those of an application executed in a general personal computer, the robot component needs to be developed to be suitable for the features of the robot application executed in the intelligent robot so that it is easily reused in the development of another robot application.

The intelligent robot is composed of various sensors for recognizing a peripheral environment (for example, an obstacle sensor using a laser and ultrasonic wave, a vision sensor using a camera, etc.), and various actuators for robot motion (for example, a wheel for a robot movement, a motor for moving a robot arm, etc.). The intelligent robot includes several computing nodes therein so as to control such many devices. In addition, these computing nodes contain programs executed independently from each other and control the robot by exchanging information with each other through a network such as serial or LAN.

Unlike a typical client/server system executed merely upon an execution request, the programs of the computing nodes mostly have an active characteristic that they always exist in an execution state to control the sensors or actuators connected to the computing nodes. For example, in case where a robot application is prepared to move the robot to a designated target point and stop the robot when there is an obstacle ahead, the robot application may be normally composed of three programs: a sensor reading program reading data from an obstacle sensor mounted in the robot; an obstacle sensing program judging the existence or absence of an obstacle on the basis of the sensor data transferred from the sensor reading program; and a robot movement program stopping the robot upon sensing the obstacle, and move the robot upon sensing no obstacle.

To be more specific, the sensor reading program cyclically reads the sensor data and sends it to the obstacle sensing program to judge the existence or absence of the obstacle. The obstacle sensing program analyzes the sensor data sent by the sensor reading program, and transfers an obstacle sensing event to the robot movement program upon sensing the obstacle. Robot movement program moves the robot to the target point, and stops the movement of the robot upon receipt of the obstacle sensing event from the obstacle sensing program. Generally, among these three programs, the sensor reading program that must cyclically read data from the sensor is an always cyclically executed active program, the robot movement program that must continuously transfer a command to a wheel motor of the robot is also a normally executed active program, and the obstacle sensing program is a passive program executed merely upon receipt of data from the sensor reading program. Normally, once the obstacle sensing program and the robot movement program are programmed, they are often reused in the development of another robot application. When such programs are developed as robot components in a standardized format, they can be easily reused. It is also possible to easily use a robot component of another enterprise developed in the standardized format to perform the same function.

As in the above example, the robot components may be an active robot component which is always executed or a passive robot component which is executed upon a request, and must be able to transmit and receive data or event such as the sensor data or obstacle sensing event to/from each other. To this end, the robot component must provide lifecycle functions such as initialization, start, end, suspension, resumption, error processing and deletion, and must be able to transfer data or event to another robot component. Moreover, as in the typical client/server program system, the robot component must be able to call a method included in another robot component.

Conventionally, development systems mainly used in the development of the robot components are largely divided into two as follows. A first development system is to call a method provided by a robot component, or read or change an attribute of the robot component, and a second development system is to read and process sensor data, perform an own operation, and transmit or receive data or event if necessary, like the typical active robot components driving the actuator.

The present invention supports the two types of robot component development systems in order to easily develop a complicated robot application and facilitate to reuse an application program.

In the following description of the present invention, a method call or data/event exchange between the robot components is conducted through a port. Also, a port for calling a method is referred to as “a method port”, a port for transferring data is referred to as “a data port”, and a port for transferring an event is referred to as “an event port”.

Hereinafter, embodiments of the present invention will be described in detail with reference to the accompanying drawings so that they can be easily implemented by those skilled in the art.

### Embodiments

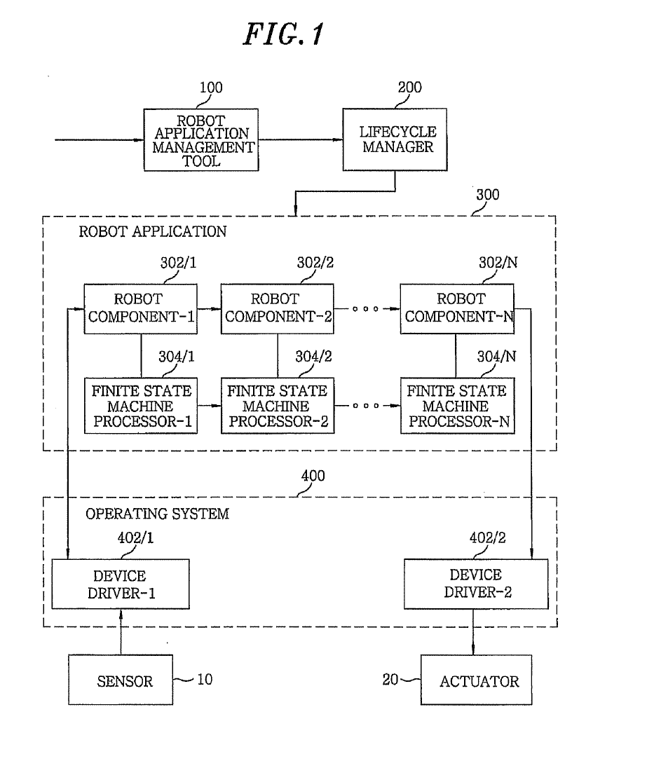

FIG. 1 illustrates a robot component management apparatus in an intelligent robot in accordance with an embodiment of the present invention. The robot component management apparatus of the present invention include a robot application management tool 100, a lifecycle manager 200, a robot application 300, an operating system 400, a sensor 10, and an actuator 60, all of which constitutes the intelligent robot.

The robot application management tool 100, which may be a graphic user interface, manages overall execution of the robot application 300 pursuant to user's request, such as to start, end, suspend or resume. In addition, the robot application management tool 100 monitors the executed states of the robot application 300, such as start, end, suspension or resumption of the robot application 300, and informs the executed states of the user.

The robot application 300 includes a plurality of robot components 302/1˜302/N, a plurality of finite state machine (FSM) processors 304/1-304/N. The FSM processors 304/1-304/N are assigned to the robot components 302/1˜302/N, respectively, and process state and state change of the robot components 302/1˜302/N. For example, the FSM processor 304/1 is assigned to the robot component 302/1 and process state and state change of the robot component 302/1.

The lifecycle manager 200 manages lifecycles of the robot components 302/1˜302/N, such as initialization, start, end and suspension of the robot components 302/1˜302/N, resumption of the suspended robot components 302/1˜302/N, and error processing, error recovery, cyclic execution and deletion of the robot components 302/1˜302/N when an error occurs during the execution of the robot components 302/1˜302/N. When the lifecycle manager 200 changes the lifecycles of the robot components 302/1˜302/N, the lifecycle manager 200 notifies such changes to the robot components 302/1˜302/N so that the robot components 302/1˜302/N can perform their necessary tasks.

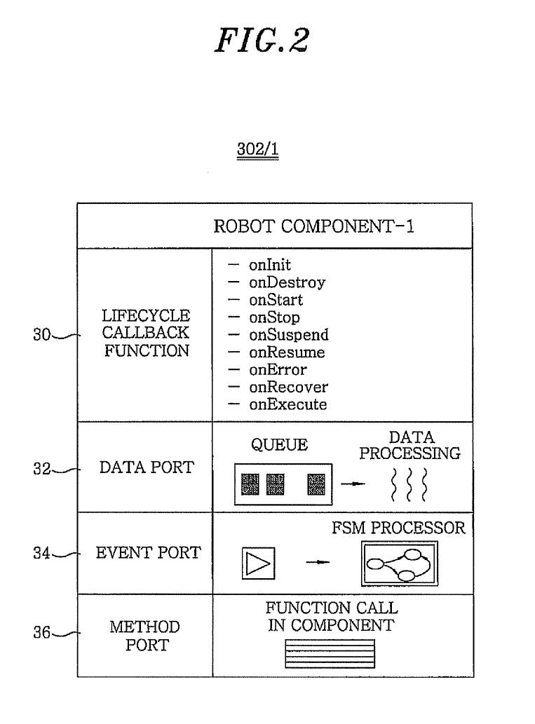

For example, memory resources allocated when a robot component 302/1 is needs to be released by the robot component 302/1 when the robot component 302/1 is ended. To do so, the robot component 302/1 needs to be implement callback functions (see, FIG. 2) describing tasks that needs to be processed whenever the lifecycles are changed, such as initialization, start, end, suspension, resumption, error processing, error recovery, cyclic execution and deletion. Therefore, whenever the lifecycles of the robot component 302/1 are changed, the lifecycle manager 200 calls an appropriate callback function related to the lifecycle change from among the callback functions of the robot component 302/1, so that the robot component 302/1 can perform a necessary operation.

The operation system 400, which may be Windows and Linux, includes a plurality of device driver and driver 402/1 and 402/2. The device driver 402/1 is an input device driver that receives analog signal from sensor 10 and delivers it to the robot component 302/1 of the robot application 300, and the device driver2 402/2 is an output device driver that delivers signal from the robot component 302/N to an actuator 20.

The sensor 10 is used to recognize peripheral environment of the intelligent robot, for example, including an obstacle sensor using laser or ultrasonic wave, or a vision sensor using cameras.

The actuator 20 is used for movement of the intelligent robot, for example, including wheels for robot movement, motors for a moving robot arm, etc.

The intelligent robot includes several computing nodes (not shown) in order to control such sensor 10 and actuator 20. These computing nodes contain programs executed independently form each other and control the intelligent robot by exchanging information with each other through a network such as serial or LAN.

FIG. 2 illustrates a configuration of for example a robot component 302/1 shown FIG. 1, which includes a lifecycle function 30, a data port 32, an event port 34, a method port 36.

The robot component 302/1 is cyclically executed when needing to cyclically read data from the sensor 10. Such cyclic execution of the robot component 302/1 is also handled by the lifecycle manager 200.

In addition, the lifecycle manager 200 is notified in the initialization when the robot component 302/1 needs to be cyclically executed, and the lifecycle manager 200 cyclically calls onExecute function of the robot component 302/1. The callback functions 30 of the robot component 302/1 are as follows:
onInit: Callback function called when the robot component 302/1 is initialized;
onDestroy: Callback function called shortly before the robot component 302/1 is deleted from a memory;
onStart: Callback function called when the robot component 302/1 is started;
onStop: Callback function called when the robot component 302/1 is ended;
onSuspend: Callback function called when the robot component 302/1 is suspended;
onResume: Callback function called when the robot component 302/1 is resumed;
onError: Callback function called when an error occurs in the robot component 302/1;
onRecover: Callback function called when the robot component 302/1 is recovered from an error; and

onExecute: Cyclically called callback function.

In addition to the lifecycle callback functions 30, the robot component 302/1 has a data port 32 for transferring data to a robot component 302/2, an event port for transferring an event to another robot component, e.g., a robot component 302/2, a FSM processor 36 for processing a finite state machine allocated to another robot component, the robot component 302/2 based on the received event, and a method port 38 for allowing a robot component 302/1 to call a function provided by another robot component, the robot component 302/2. The data port 32 is used for exchanging data between the robot components, for example between robot component and component2 302/1 and 302/2. The robot component intended to transmit data, the robot component 302/1, need to be provided with an output data port, and the robot component intended to receive data, the robot component 302/2, need to be provided with an input data port. The data port 32 transferring and receiving data to/from each other needs to have the same type of data.

Since the data port 32 supports a publisher/subscriber model, one output data port can transmit data to several input data ports. The input data port can receive the data transferred from the output data port, and includes a queue for storing the data therein. The queue in the input data port can specify a maximum size of data to be stored. When data over the maximum size is inputted, any one of the data in the queue is removed, and the newly transferred data is stored in the queue. In case where the maximum size of the queue is 1, the queue always maintains only the latest data. In the present invention, the queue is mainly used when only the latest sensor data is needed. The data transferred to the input data port is stored in the queue of the input data port by a thread allocated by the lifecycle manager 200. The data stored in the input data port is processed later in the cyclically executed onExecute function.

The event port 34 is dedicated to transmit and receive an event between the robot components, for example, between the robot component and component 302/1 and 302/2. The robot component intended to transmit an event, the robot component 302/1, needs to be provided with an output event port, and the robot component intended to receive an event, the robot component 302/2, needs to be provided with an input event port. The event ports 34 transferring and receiving an event to/from each other need to process the same type of event. An event transfer scheme is similar to the publisher/subscriber scheme as in the data port 32. However, while the data port 32 receiving data stores the data in the queue and processes it later, the event port 34 receiving an event does not store the event in the queue but processes it immediately by a thread allocated by the lifecycle manager 200. Therefore, the event port 34 is used when an immediate processing is necessary, such as stopping when an obstacle is found.

In addition, the event transferred to the event port can be processed in association with a finite state machine (FSM). The FSM is a program system often used generally in a robot programming. One finite state machine is composed of several states, and has one state at a specific time point. Upon receipt of a specific event, the finite state machine changes its state in accordance with the event. For example, in case where one finite state machine is composed of “movement state to destination” and “obstacle finding state”, when moving from a current position to a specific destination, the FSM first stays in the “movement state to destination” and then continuously moves to the destination. Upon receipt of an obstacle finding event, the finite state machine transits to the “obstacle finding state”, and stops the robot. Thereafter, upon receipt of an obstacle absence event, the FSM returns to the “movement state to destination” and moves to the destination. As in the above example, the event is used when there is a need of immediate processing, unlike the data. Accordingly, the event port 34 is necessary separately from the data port 32.

The FSM processor 36 serves to change the state of the finite state machine on the basis of the event received at the event port 34 of the robot component 302/1. The data port 32 and the event port 34 take a non-blocking call. After the robot component 302/1 transfers data or event through the data port 200 or the event port 300, the robot component 302/1 can perform subsequent tasks without waiting for processed results of the preceding tasks. If the robot component 302/1 continuously waits for the processed result to be returned after transferring the data or event, the robot component 302/1 may not be able to process more important data or event occurring. For this reason, the data port 32 and the event port 34 supports only the non-blocking call. If the processed result of the data or event is necessary, a robot component processing the data or event, for example, the robot component 203/1, or a robot component sending the data or event in the form of data or event, for example, the robot component 302/2 needs to send the processed result to the robot component 302/1.

The robot component 302/1 can call through the method port 38 a series of methods provided by other robot component, the robot component 302/2. The robot component intended to call a method, for example, the robot component 302/1, needs to have a required method port, and the robot component intended to provide a method, the robot component 302/2, needs to have a provided method port. The required method port and the provided method port are required to be composed of the same methods.

In case where the robot component 302/1 calls a method through the method port 38, the robot component 302/1 can perform both a blocking call where the robot component 302/1 needs to wait for a result value to be returned after the execution of the method is ended, and a non-blocking call where the robot component2 302/2 can return the method immediately without waiting for a result value. The non-blocking call can be implemented merely in a method call which does not have a return value.

The method call required through the required method port is processed immediately by a thread allocated by the lifecycle manager 200. In the case of the blocking call, the result of the method call is returned to the robot component performing the method call through the required method port by the lifecycle manager 200.

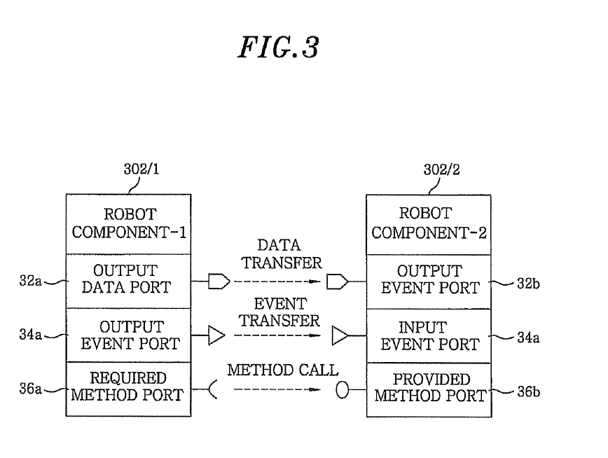

FIG. 3 illustrates the port connection relation between the robot components, for example between the robot components 302/1 and 302/2, in accordance with an embodiment of the present invention.

A robot component 302/1 includes an output data port 32a to transfer data to a robot component 302/2, an output event port 34a to transfer an event to the robot component2 302/2, and a required method port 36a to call a method provided by the robot component 302/2.

The robot component 302/2 includes an input data port 32b to receive the data transferred from the robot component 302/1, an input event port 34b to receive the event transferred from the robot component 302/1, and a provided method port 36b to process the method call of the robot component 302/2 called by the robot component 302/1.

A data type transmitted by the output data port 32a is required be identical to a data type received by the input data port 32b, and an event type transmitted by the output event port 34a is required also be identical to an event type received by the input event port 34b. Likewise, a method signature called by the required method port 36a is required also be identical to a method signature processed by the provided method port 36b.

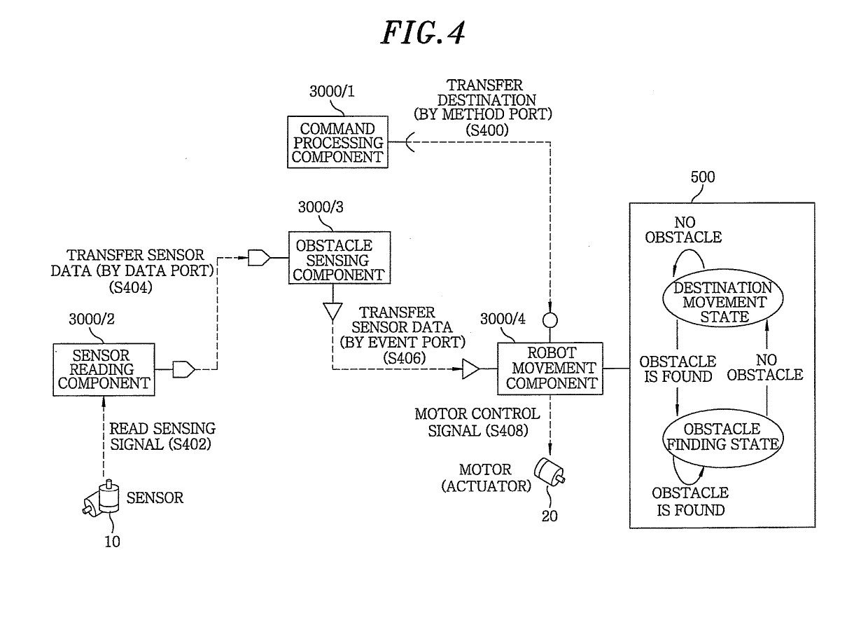

FIG. 4 illustrates a robot application prepared by a method for developing a robot component in accordance with an embodiment of the present invention.

In FIG. 4, four robot components, a command processing component 3000/1, a sensor reading component 3000/2, an obstacle sensing component 3000/3 and a robot movement component 3000/4, constitute the robot application. It is assumed that the four robot components 30000/1˜3000/4 have been executed in advance by a lifecycle manager 200.

As illustrated in FIG. 4, the command processing component 3000/1 serves to transfer a movement destination provided by a user to the robot movement component 3000/4 through a method port, e.g., using a screen or keyboard installed on the intelligent robot, in step S400.

Then the sensor reading component 3000/2 reads an analog signal from a sensor 10, and converts the analog signal into sensor data in step S402.

The sensor reading component 3000/2 transfers the sensor data to the obstacle sensing component 3000/3 through a data port in step S404.

The obstacle sensing component 3000/3 judges the existence or absence of an obstacle on the basis of the sensor data transferred from the sensor reading component 3000/2, and transfers an obstacle sensing event upon sensing an obstacle or an obstacle absence event upon finding no obstacle to the robot movement component 3000/4 through an event port in step S406.

In response thereto, the robot movement component 3000/4 sends a control signal to the actuator 20 through a method port so that the robot moves to the destination in step S408. The robot movement component 3000/4 stops the movement of the robot upon receipt of the obstacle sensing event from the obstacle sensing component 3000/3 by transferring a control signal for interrupting the movement to the actuator 20. Meanwhile, upon receipt of the obstacle absence event from the obstacle sensing component 3000/3, the robot movement component 3000/4 sends a control signal to the actuator 20 so that the robot resumes the movement to the destination.

In FIG. 4, the robot movement component 3000/4 contains one FSM and a FSM processor 500 for processing the FSM.

In case where the FSM is composed of ‘movement state to destination’ and ‘obstacle finding state’ and the robot moves from a current position to the destination transferred from the command processing component 3000/1, the FSM continuously moves the robot to the destination while maintaining the robot in the ‘movement state to destination’. Upon receipt of the obstacle finding event from the obstacle sensing component 3000/3, the FSM transits to the ‘obstacle finding state’, reduces a speed of the robot, and changes a movement direction of the robot. Meanwhile, upon receipt of the obstacle absence event from the obstacle sensing component 3000/3, the FSM returns to the ‘movement state to destination’, and makes the robot move to the destination again.

In case where the sensor reading component 3000/2, the obstacle sensing component 3000/3, and the robot movement component 3000/4 described in the above embodiment have the same input, output and event ports, they can easily be reused in the development of another robot application. Moreover, since the lifecycle manager 200 processes the functions such as lifecycle management, data transfer, event transfer, method call, cyclic execution, and finite state machine processing, it is possible to rapidly and easily develop the robot components, and minimize errors. Also, what a robot application developer needs to do is only to implement operations to be conducted by the robot components.

Accordingly, since it becomes possible to easily develop, reuse, and maintain the robot components by means of the method for developing the robot components suggested by the present invention, there are advantages of reducing a development time of a robot application and easily using a robot component developed by another enterprise.

While the invention has been shown and described with respect to the embodiments, it will be understood by those skilled in the art that various changes and modification may be made without departing the scope of the present invention as defined in the following claims.

What is claimed is:

1. An apparatus for managing robot components in an intelligent robot having a sensor and an actuator, which comprises:
a robot application including a plurality of robot components;
a robot application management tool that manages the operation of the robot application, monitors the status caused by the operations of the robot application and information on the robot components;
a lifecycle manager that manages lifecycles of the robot components under the management of the robot application management tool; and
an operation system that transfers a sensing signal about peripheral environment generated from the sensor to the robot application, and transfers an execution signal from the robot application to the actuator.

2. The apparatus of claim 1, wherein the lifecycle manager calls a lifecycle callback function according to change in a lifecycle of each of the robot components when the lifecycle of each of the robot components is changed, to make each of the robot components perform its necessary tasks, wherein the lifecycle callback function describes a task of each of the robot components that needs to be processed.

3. The apparatus of claim 2, wherein the lifecycle callback function includes any one of initialization, start, end, suspension, resumption after the suspension, error-processing, error-recovery, cyclical execution and deletion of to be processed in each robot component.

4. The apparatus of claim 1, wherein the robot application performs any one operation of execution start, end, suspension and resumption thereof.

5. The apparatus of claim 1, wherein the robot application includes a finite state machine assigned to each robot component to process state and state change of each robot component, respectively.

6. The apparatus of claim 1, wherein each of the robot components includes:
a data port for transferring a data therefrom to another robot components;
an event port for transferring an event therefrom to another robot component; and,
a method port for calling a method provided in another robot component.

7. The apparatus of claim 6, wherein the data port is an input/output data port for transferring/receiving data and supports a non-blocking call.

8. The apparatus of claim 6, wherein the event port is an input/output event port for transferring/receiving an event and supports a non-blocking call.

9. The apparatus of claim 6, wherein the method port is a required/provided method port for calling/providing a method and supports both blocking and non-blocking call.

10. A method for managing a plurality of robot components being executed by a lifecycle manager in an intelligent robot having a sensor and an actuator, which comprises:
transferring a designated destination from a command process component to a robot movement component through a method port;
converting a sensing signal received by the sensor into sensor data in a sensing component;
transferring the sensor data to an obstacle sensing component to judge an existence or absence of obstacles based on the sensor data;
generating an event on the basis of judgment of the existence or absence of obstacles to transfer the event to the robot movement component; and
transferring to the actuator a control signal depending on the event transferred to the robot movement component and the destination transferred through the method port.

11. The apparatus of claim 10, wherein the event is an obstacle-sensing event or an obstacle-free event.
